(19) United States
(12) Patent Application Publication
(10) Pub. No.: US 2023/0012768 A1
(43) Pub. Date: Jan. 19, 2023

(54) DISPLAY CONTROL APPARATUS, DISPLAY CONTROL SYSTEM, AND DISPLAY CONTROL METHOD

(71) Applicant: Panasonic Intellectual Property Management Co., Ltd., Osaka (JP)

(72) Inventors: Masahito OISHI, Kanagawa (JP); Tadahiro UCHIKOSHI, Kanagawa (JP); Kojiro ONO, Kanagawa (JP)

(73) Assignee: Panasonic Intellectual Property Management Co., Ltd., Osaka (JP)

(21) Appl. No.: 17/953,730

(22) Filed: Sep. 27, 2022

Related U.S. Application Data
(63) Continuation of application No. PCT/JP2021/012217, filed on Mar. 24, 2021.

(30) Foreign Application Priority Data
Mar. 30, 2020 (JP) 2020-060560

(51) Int. Cl. G06F 9/455; B60Q 9/00

(52) U.S. Cl. CPC G06F 9/45558; B60Q 9/00; G06F 2009/45591

(57) ABSTRACT

The present disclosure facilitates providing a display control apparatus, a display control system, and a display control method. The display control apparatus includes: a first OS that controls execution of a first application for generating a first display image displayed on a first display apparatus mounted on a vehicle; a second OS that controls execution of a second application for generating a second display image displayed on a second display apparatus mounted on the vehicle; and a hypervisor that is executed on a processor and controls execution of the first OS and the second OS.

### TECHNICAL FIELD

The present disclosure relates to a display control apparatus, a display control system, and a display control method.

### BACKGROUND ART

The Patent Literature (hereinafter referred to as “PTL”) discloses a technique for displaying an alert image for informing a driver of the presence of an object near a vehicle on a display device located in a direction of a sight line of the driver among a plurality of display devices equipped to the vehicle.

### CITATION LIST

### Patent Literature

PTL: Japanese Patent Application Laid-Open No. 2016-91055.

### SUMMARY OF INVENTION

### Technical Problem

However, this type of related art uses only one Operating System (OS) to control a plurality of display apparatuses such as a navigational device, an electronic mirror, and the like. Therefore, for example, at the time of control, displaying of the images by all of the plurality of display apparatuses may be unstable at the same time.

Anon-limiting embodiment of the present disclosure facilitates providing a display control apparatus, a display control system, and a display control method each capable of improving the stability of displaying of images by a plurality of display apparatuses.

### Solution to Problem

A display control apparatus according to an exemplary embodiment of the present disclosure includes: a first Operating System (OS) that controls execution of a first application for generating a first display image displayed on a first display apparatus mounted on a vehicle; a second OS that controls execution of a second application for generating a second display image displayed on a second display apparatus mounted on the vehicle; and a hypervisor that is executed on a processor and controls execution of the first OS and the second OS.

A display control system according to an exemplary embodiment of the present disclosure includes: a first OS that controls execution of a first application for generating a first display image displayed on a first display apparatus mounted on a vehicle; a second OS that controls execution of a second application for generating a second display image displayed on a second display apparatus mounted on the vehicle; and a hypervisor that is executed on a processor and controls execution of the first OS and the second OS.

A display control method according to an exemplary embodiment of the present disclosure is executed in a display control apparatus, the display control method including: controlling, by a first OS, execution of a first application for generating a first display image displayed on a first display apparatus mounted on a vehicle; controlling, by a second OS, execution of a second application for generating a second display image displayed on a second display apparatus mounted on the vehicle; and controlling, by a hypervisor that is executed on a processor, execution of the first OS and the second OS.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates a configuration example of display control system 100 according to an embodiment of the present disclosure;

FIG. 2 is a diagram for describing the configuration example of display control system 100 according to the embodiment of the present disclosure;

FIG. 3 illustrates an example in which a layer of a hypervisor is built on hardware, and layers of two guest OSs are built thereon;

FIG. 4 illustrates an example in which a host OS is built on hardware, and a hypervisor is built thereon;

FIG. 5 is a sequence chart for describing an operation of display control system 100 in this case;

FIG. 6 is a diagram for describing an operation of display control system 100 in a case where a trouble occurs in guest OS 30A1 of display apparatus 30A;

FIG. 7 is a sequence chart for describing an operation in FIG. 6;

FIG. 8 is another diagram for describing an operation of display control system 100 in a case where a trouble occurs in guest OS 30A1 of display apparatus 30A;

FIG. 9 is a sequence chart for describing an operation in FIG. 8;

FIG. 10 is a sequence chart for describing an operation example of display control system 100 in a case where hypervisor 70 monitors each guest OS;

FIG. 11 is a sequence chart for describing an operation example of display control system 100 in a case where monitoring guest OS 90 monitors a status of each guest OS; and

FIG. 12 is a sequence chart for describing an operation example in a case where each guest OS mutually monitors a status of another guest OS in display control system 100.

### DESCRIPTION OF EMBODIMENTS

Preferred embodiments of the present disclosure will be described in detail with reference to the attached drawings. Note that elements having substantially the same functions are assigned the same reference numerals in the description and drawings to omit duplicated descriptions thereof.

### EMBODIMENT

First, a description will be given of the background leading to the creation of an embodiment according to the present disclosure. In a publicly known art (e.g., technique described in PTL), only one Operating System (OS) is used to control, for example, a plurality of display apparatuses such as one or more navigation devices and one or more electronic mirrors. Therefore, for example, at the time of control, displaying of the images by all of the plurality of display apparatuses may be unstable at the same time. By way of example, in a case where a trouble occurs in software corresponding to a navigation device on which an alert image is displayed and thus the navigation device becomes uncontrollable, the trouble may spread to the OS or spread to other software, so that other display apparatuses (e.g., vehicle instrument panel or electronic mirror) may be also uncontrollable. Hence, it is desired that the stability of displaying by each of the plurality of display apparatuses can be improved. Hereinafter, the embodiment according to the present disclosure will be described.

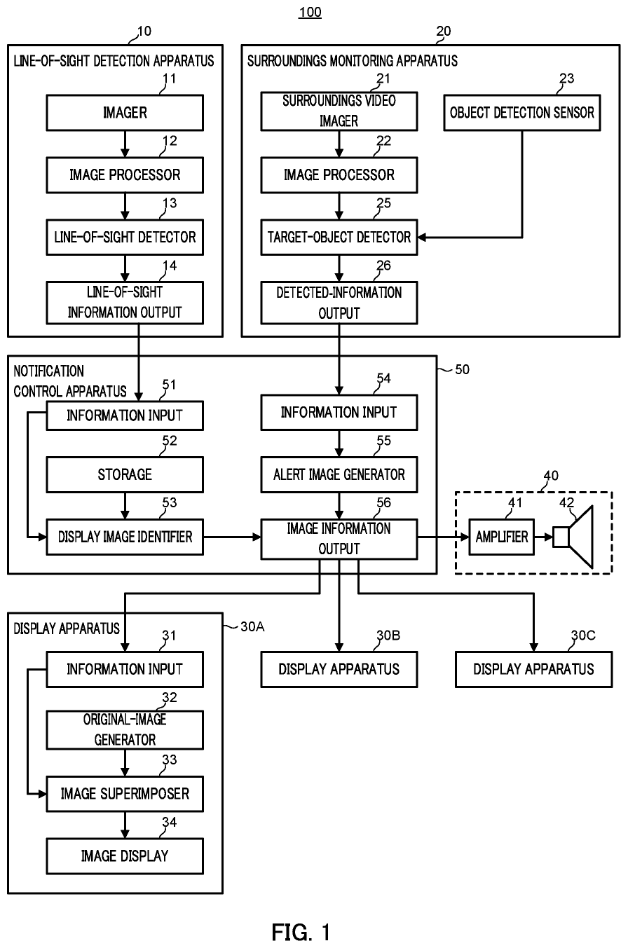

FIG. 1 illustrates a configuration example of display control system 100 according to the embodiment of the present disclosure. Display control system 100 is mounted on a vehicle such as a passenger vehicle, a freight vehicle, a ride-sharing vehicle, and the like. Display control system 100 includes line-of-sight detection apparatus 10 for sequentially detecting a line-of-sight of a vehicle driver, surroundings monitoring apparatus 20 for monitoring an object present around the vehicle, a plurality of display apparatuses 30A to 30C, sound output apparatus 40, and notification control apparatus 50. In the following, when the plurality of display apparatuses 30A to 30C are not distinguished, they are simply referred to as “display apparatus 30.”

(Configuration of Line-of-Sight Detection Apparatus 10)

Line-of-sight detection apparatus 10 is an exemplary first detection apparatus according to the present disclosure. Line-of-sight detection apparatus 10 is capable of detecting a line-of-sight direction of the vehicle driver. As illustrated in FIG. 1, line-of-sight detection apparatus 10 includes, for example, imager 11, image processor 12, line-of-sight detector 13, and line-of-sight information output 14.

Imager 11 is an internal imager that includes a imaging element such as a Charge Coupled Device (CCD) and/or a Complementary Metal Oxide Semiconductor (CMOS) and images the interior of the vehicle. Imager 11 is provided at a position where the face of the driver can be captured, captures an image including the face of the driver, and sequentially outputs, to image processor 12, image information, which is information indicating a content of the captured image.

When the image information is input, image processor 12 performs binarization processing on the image imaged by imager 11 and thereby obtains a binary image. Image processor 12 inputs, to line-of-sight detector 13, binary image information, which is information indicating a content of the binary image.

Line-of-sight detector 13 detects a line-of-sight based on the binary image information. For example, line-of-sight detector 13 identifies an eyeball area of the driver by analyzing the binary image while stereoscopically viewing eyeball shapes to obtain eyeball center coordinates from its curvature. Line-of-sight detector 13 identifies a black eye (pupil) area from the eyeball area to obtain black eye center coordinates, and determines a direction from the eye center coordinates to the black eye center coordinates as a line-of-sight direction (line-of-sight vector). Line-of-sight detector 13 identifies a straight line starting from an eyeball position and extending from the eyeball position to the line-of-sight direction as a line-of-sight, and inputs line-of-sight information, which is information indicating the identified line-of-sight, to line-of-sight information output 14. Line-of-sight information output 14 outputs the line-of-sight information to information input 51 of notification control apparatus 50.

(Configuration of Surroundings Monitoring Apparatus 20)

Surroundings monitoring apparatus 20 is an exemplary second detection apparatus according to the present disclosure. Surroundings monitoring apparatus 20 is capable of detecting an object present around the vehicle. As illustrated in FIG. 1, surroundings monitoring apparatus 20 includes, for example, surroundings video imager 21, image processor 22, object detection sensor 23, target-object detector 25, and detected-information output 26.

Surroundings video imager 21 is an external imager such as an omnidirectional camera and/or a panoramic camera that includes an imaging element such as the CCD and/or the CMOS and images a video (including still images) around the vehicle. In the following, a video around the vehicle is referred to as a “surroundings video.” Examples of the surroundings videos include a landscape in front of the vehicle, a landscape on the side of the vehicle (driver-seat-door side of vehicle or passenger-seat-door side of vehicle), a landscape behind of the vehicle, and the like. Examples of the landscapes include an object present on a roadway on which the vehicle is traveling and the like. Examples of the objects present on the roadway include a vehicle, a building, a structure (e.g., advertisement, road sign, traffic light, and telegraph pole), a person, an animal, and the like.

Surroundings video imager 21 is positioned on, for example, a position where landscapes outside the vehicle can be imaged. Such position includes a front grill, a side mirror, a ceiling, a rear bumper, and the like. Surroundings video imager 21 inputs, to image processor 22, surroundings video information, which is information indicating a content of the captured surroundings video.

Image processor 22 performs, based on the surroundings video information, image processing for detecting an object that is a previously set detection target from among the objects present around the vehicle. In the following, the object that is a previously set detection target is referred to as a “target-object.” Examples of the target-objects include a passenger vehicle, a motorcycle, a bus, a taxi, a bicycle, a pedestrian, an animal, and the like. Examples of the image processing include, for example, edge detection processing and the like. Image processor 22 inputs, to target-object detector 25, target image information indicating a content of an image of the target-object.

Object detection sensor 23 is a sensor for detecting a position of an object present around the vehicle and is, for example, a sonar. When the sonar oscillates a pulsed sound wave of a constant frequency, for example, the pulsed sound wave is reflected upon hitting the object around the vehicle and the like, and thus, part of the pulsed sound waves returns to the sonar. The longer a distance from the vehicle to the object is, the longer a time between the oscillation of the pulsed sound wave from the sonar and the return of the part thereof to the sonar is. Taking advantage of this relation, the sonar estimates a distance to the object by measuring a round-trip time from the oscillation of the pulsed sound wave to the return of an echo reflected by the object to the sonar, and detects, based on the estimated distance, a position of the object with respect to the vehicle. Object detection sensor 23 inputs, to target-object detector 25, object position information, which is information indicating a position of the detected object.

Target-object detector 25 performs the following determination based on the target image information and the object position information.

1. Target-object detector 25 determines that there is no risk of collision by using information included in target-object detection information (information on direction of preceding vehicle, distance to preceding vehicle, and the like) in a case where, for example, a rear end of a preceding vehicle, which is the detection target, is present in front of the vehicle, and a distance from the rear end to a front end of the vehicle is equal to or greater than a predetermined value (e.g., several meters to several tens of meters) that varies according to a relative speed.

2. Target-object detector 25 determines that there is a risk of collision by using the information included in the target-object detection information in a case where, for example, the rear end of the preceding vehicle, which is the detection target, is present in front of the vehicle, and the distance is less than the predetermined value.

In the manner described above, target-object detector 25 detects a target-object (such as preceding vehicle) that may collide with the vehicle, generates the target-object detection information, which is information indicating that the target-object that may collide with the vehicle has been detected, and inputs the information to detected-information output 26. Detected-information output 26 outputs the target-object detection information to notification control apparatus 50. The target-object detection information includes information indicating a direction in which the target-object is present, information indicating a distance from the vehicle to the target-object, and the like.

(Configuration of Notification Control Apparatus 50)

Notification control apparatus 50 is an exemplary display control apparatus according to the present disclosure. Notification control apparatus 50 includes a first OS, a second OS, and a hypervisor. Here, the first OS controls execution of a first application that generates a first display image displayed on a first display apparatus among the plurality of display apparatuses 30A to 30C. The second OS generates a second display image displayed on a second display apparatus of the plurality of display apparatuses 30A to 30C. The hypervisor is executed on a processor and controls execution of the first OS and the second OS.

For example, notification control apparatus 50 first identifies, based on a detection result by line-of-sight detection apparatus 10, any of the plurality of display apparatuses 30A to 30C that is present in the line-of-sight direction of the vehicle driver. Then, among a plurality of OSs provided in notification control apparatus 50, at least one OS corresponding to the subject-display apparatus causes, based on a detection result by surroundings monitoring apparatus 20, the subject-display apparatus to display an alert image for notifying the driver of the presence of the detected object. The plurality of OSs includes at least the first OS and the second OS.

For example, the hypervisor controls, such that the alert image sequentially moves from an original display position to a display position corresponding to a presence position of the object among the plurality of display apparatuses 30A and 30C (or only in original display apparatus), one or more OSs including at least an OS corresponding to the original display apparatus.

Hereinafter, an exemplary functional configuration of such notification control apparatus 50 will be described in more detail. As illustrated in FIG. 1, notification control apparatus 50 includes, for example, information input 51, storage 52, display image identifier 53, information input 54, alert image generator 55, and image information output 56. Here, information input 51, storage 52, display image identifier 53, information input 54, alert image generator 55, and image information output 56 may be configured as applications, respectively. Further, alert image generator 55 is an exemplary first application and an exemplary second application according to the present disclosure. Note that notification control apparatus 50 may include two or more alert image generators 55.

Information input 51 inputs the line-of-sight information output from line-of-sight information output 14 and transfers it to display image identifier 53. Storage 52 stores coordinate data. The coordinate data indicates positions in the vehicle of respective display surfaces of the plurality of display apparatuses 30.

Display image identifier 53 identifies display apparatus 30 present in a direction toward which a line-of-sight of the driver is directed, based on the line-of-sight information and the coordinate data. For example, by using the coordinate data, display image identifier 53 can identify display apparatus 30 present on the line-of-sight of the driver, with the front of the vehicle instrument panel as a reference position, for example. Display image identifier 53 inputs, to image information output 56, an identification ID (Identifier) of display apparatus 30 that has been identified.

Incidentally, when the line-of-sight does not cross any of the display surfaces of the plurality of display apparatuses 30, display image identifier 53 may be configured to identify display apparatus 30 present at the closest position from the line-of-sight as display apparatus 30 present in a direction toward which the line-of-sight of the driver is directed, and to input, to image information output 56, the identification ID of display apparatus 30 that has been identified.

Display image identifier 53 may also be configured to refer to spatial data so as to identify display apparatus 30 present in a small area toward which the line-of-sight of the driver is directed as display apparatus 30 present in the direction toward which the line-of-sight of the driver is directed. The spatial data is related to vehicle-interior space obtained by dividing space in front of the driver into a plurality of small areas. The spatial data is set to in advance, for example, display image identifier 53 or storage 52.

Information input 54 inputs the target-object detection information output from detected-information output 26 and transfers it to alert image generator 55.

Alert image generator 55 generates, based on the target-object detection information, alert image information and inputs it to image information output 56. The alert image information is information indicating an image for alerting the driver that an object that may collide is present around the vehicle. In the following, the image for alerting is referred to as an “alert image.” The alert image may include, for example, a symbol such as “!” or may include a letter message such as “collision risk.”

Image information output 56 outputs the alert image information generated by alert image generator 55 to display apparatus 30 corresponding to the identification ID.

(Configuration of Display Apparatus 30)

Display apparatus 30A includes information input 31, original image generator 32, image superimposer 33, and image display 34. Each of display apparatus 30B and display apparatus 30C is configured similarly to display apparatus 30A. Display apparatus 30A, display apparatus 30B, and display apparatus 30C are each an exemplary first display apparatus or an exemplary second display apparatus according to the present disclosure. Further, original image generator 32 and image superimposer 33 are each an example of the first application or the second application according to the present disclosure.

Display apparatus 30A is, for example, a center display provided in the vehicle interior. Display apparatus 30B is, for example, a vehicle instrument panel provided in front of the driver seat. Display apparatus 30A and display apparatus 30B are arranged in, for example, a dashboard provided in the vehicle interior. Display apparatus 30C is, for example, a head-up display. The number of display apparatuses 30 provided to the vehicle is not limited to three and may be two or four or more. Further, the type of display apparatus 30 provided to the vehicle is not limited to these and may include, for example, an electronic mirror combining an in-vehicle camera and a display (e.g., electronic room mirror or electronic side mirror).

Information input 31 inputs the alert image information output from image information output 56 and transfers it to image superimposer 33.

Original image generator 32 generates original image information and inputs it to image superimposer 33. The original image information is information indicating a content of an image (original image) displayed on image display 34 when there is no target-object that may collide around the vehicle.

Examples of the original images displayed on image display 34 of display apparatus 30A include an images of a map, an operation screen of an audio device, and the like.

Examples of the original images displayed on image display 34 of display apparatus 30B include images of a speedometer, a hydraulic pressure gauge, a residual fuel gauge, and the like.

Examples of the original images displayed on image display 34 of display apparatus 30C include an image indicating a vehicle speed, an image indicating a vehicle traveling direction, and the like.

Image superimposer 33 generates, based on the original image information and the alert image information, superimposed-image information indicating an image obtained by superimposing the alert image on the original image, and inputs the resulting information to image display 34. Image display 34 generates a superimposed image based on the superimposed-image information and displays the superimposed image on a screen of image display 34. The superimposed image is an example of a first display image or a second display image according to the present disclosure.

Thus, for example, in the traveling vehicle, when a vehicle-to-vehicle distance between the preceding vehicle is narrowed while the driver is looking at the screen of display apparatus 30A (e.g., operation screen of audio device), an alert image is superimposed and displayed on the original image of display apparatus 30A. Therefore, as compared to a case where an alert image is displayed on another display apparatus (e.g., head-up display and the like) that is other than display apparatus 30A and is positioned far from the line-of-sight, it is possible to quickly notify the driver of a situation where the vehicle may collide with the object around the vehicle, and the driver immediately can take a collision avoidance action such as braking and steering, accordingly.

(Configuration of Sound Output Apparatus 40)

Sound output apparatus 40 includes amplifier 41 and speaker 42. Amplifier 41 amplifies a sound signal representing an operation guidance voice output from image information output 56 and inputs the resulting signal to speaker 42. Speaker 42 converts the sound signal from amplifier 41 to a sound and outputs the sound.

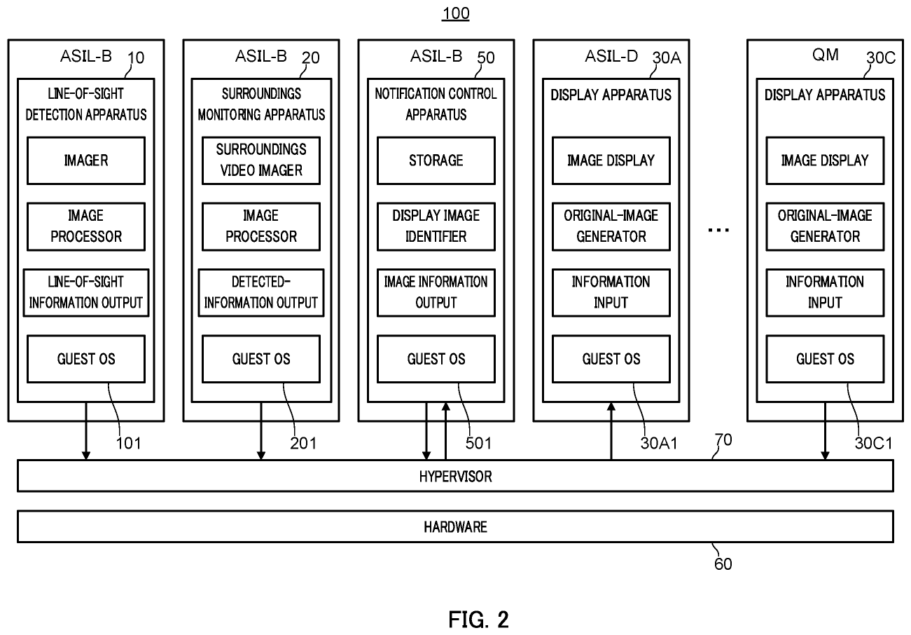

FIG. 2 is another diagram for describing a configuration example of display control system 100 according to the embodiment of the present disclosure. Display control system 100 includes hardware 60, hypervisor 70, line-of-sight detection apparatus 10, surroundings monitoring apparatus 20, notification control apparatus 50, and a plurality of display apparatuses 30. The plurality of display apparatuses 30 includes the first display apparatus and the second display apparatus mounted on the vehicle.

Hardware 60 includes a processor having a Central Processing Unit (CPU), an Electronic Control Unit (ECU), or the like (none of them is illustrated) and provides an execution environment for a plurality of computer programs. Hardware 60 may be configured to include a single processor or a plurality of processors. The plurality of processors may constitute a display control system according to the present embodiment.

A virtual layer of hypervisor 70 is built on hardware 60. Hypervisor 70 may be virtualization software that is executed on hardware 60 and controls execution of a plurality of guest OSs 101 to 30C1. Incidentally, the plurality of guest OSs 101 to 30C1 is each an example of the first OS or the second OS according to the present disclosure. Hypervisor 70 allows different and a plurality of guest OSs to be virtualized and mounted on hardware 60. That is, a plurality of virtual information processing apparatuses (virtual machines) can be realized on one information processing apparatus. An example of hypervisor-type virtualization software includes “COQOS Hypervisor SDK,” “QNX Hypervisor,” or the like, and these can be used in the present embodiment, but the virtualization software is not limited to these examples.

Guest OS 101 is an OS that controls execution of an application in which line-of-sight detection apparatus 10 generates line-of-sight detection information. For example, Automotive Safety Integrity Level (ASIL)-B is applied to the application. The ASIL will be described in detail later.

Guest OS 201 is an OS that controls execution of an application in which surroundings monitoring apparatus 20 generates the target-object detection information. For example, ASIL-B is applied to the application.

Guest OS 501 is an OS that controls execution of an application in which notification control apparatus 50 generates the image information. For example, ASIL-B is applied to the application. Guest OS 501 is an example of the first OS or the second OS according to the present disclosure. The application is an example of the first application or the second application according to the present disclosure. Note that, in FIG. 2, an example is illustrated in which notification control apparatus 50 has one guest OS 501, but the present disclosure is not limited to this example. Notification control apparatus 50 may have two or more guest OSs 501. In this case, first guest OS 501 of two or more guest OSs 501 may be associated with any one type of the plurality of display apparatuses 30, and second guest OS 501 of two or more guest OSs may be associated with another one type of the plurality of display apparatuses 30.

Alternatively, notification control apparatus 50 may include, as well as guest OS501, one or more OSs 502 different in type and other than from guest OS 501. This OS 502 may be a guest OS or may not be the guest OS. Note that OS 502 is an example of the first OS or the second OS according to the present disclosure. Further, guest OS 501 may be associated with any one type of the plurality of display apparatuses 30, and OS 502 may be associated with another one type of the plurality of display apparatuses 30.

Guest OS 30A1 is an OS that controls execution of an application in which display apparatus 30A displays an image. For example, ASIL-D is applied to the application.

Guest OS 30C1 is an OS that controls execution of an application in which display apparatus 30C displays an image. For example, ASIL-QM is applied to the application.

The ASIL is an index that specifies safety requirements and safety measures for automobiles, which is defined in ISO 26262 that is a functional safety standard for the automotive industry. The ASIL has five safety levels D, C, B, A, and QM defined in descending order of safety standards. For example, an airbag, an anti-lock brake system, a power steering, and the like have the highest risk caused by a failure, and thus, ASIL-D, which is the most stringent requirement for ensuring safety, is applied to these mechanisms. Note that ASIL-A is applied to backlights, ASIL-B is applied to headlights, brake lamps, and the like, and ASIL-C is applied to a cruise control. In this case, guest OSs may have high safety standards, in descending order of guest OS 30A1, guest OS501, and guest OS 30C1, for example.

Hypervisor 70 enables display control system 100 according to the present embodiment to operate a plurality of virtual machines in parallel. Therefore, for example, even when a trouble occurs in any one of applications of the plurality of display apparatuses 30, an operation of display apparatus 30A having a high safety requirement level can be continued without any impact of the trouble on the applications of the other display apparatuses 30 having no trouble.

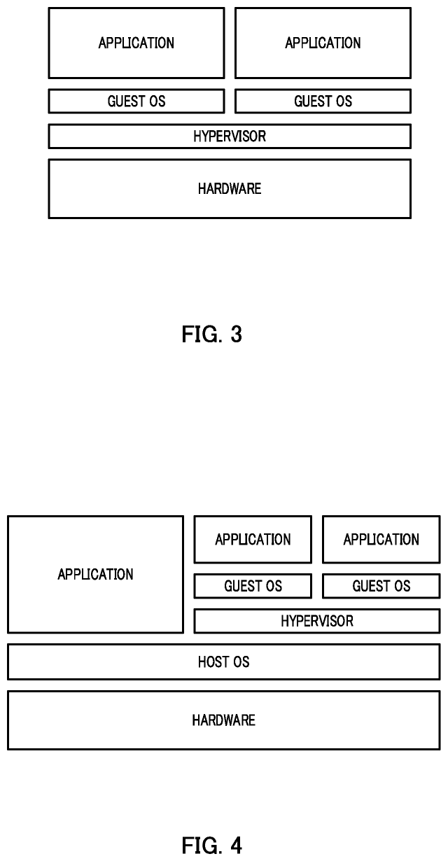

The configuration of display control system 100 is not limited to the example of FIG. 2 and may be configured as in FIGS. 3 and 4. FIG. 3 illustrates an example in which a layer of the hypervisor is built on the hardware, and layers of two guest OSs are built thereon. FIG. 4 illustrates an example in which a host OS is built on the hardware, and the hypervisor is built thereon. The host OS is, for example, an OS that controls execution of an application for traveling control of the vehicle. Incidentally, the host OS is an example of the first OS or the second OS according to the present disclosure.

(Operation)

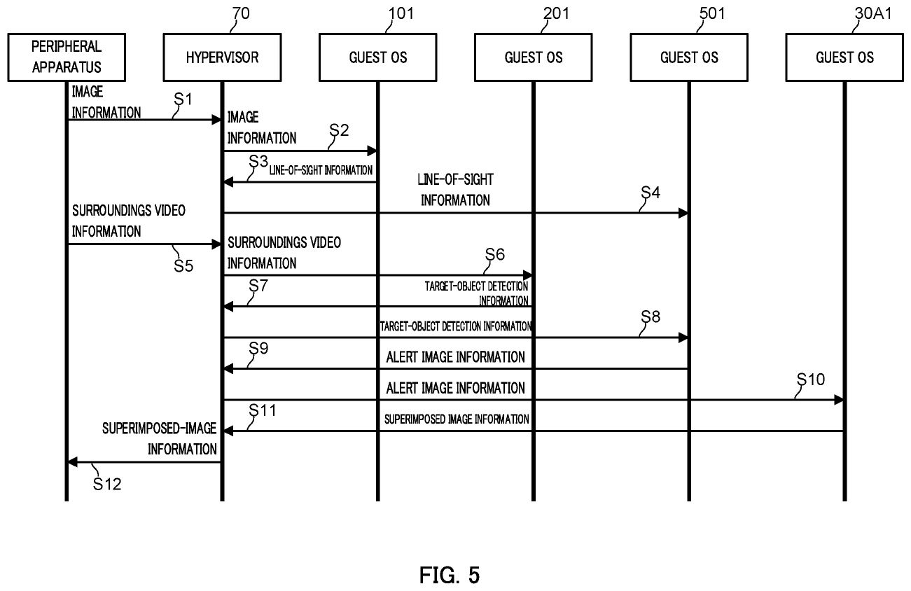

Next, an operation of display control system 100 will be described. First, with reference to FIG. 5, a description will be given of an operation for causing display apparatus 30A to display an alert image in a case where no trouble occurs in guest OS 30A1 of display apparatus 30A present in a direction toward which a line-of-sight of the driver is directed.

FIG. 5 is a sequence chart for describing an operation of display control system 100 in this case. When hypervisor 70 receives image information transmitted from a peripheral apparatus (e.g., imager 11) (step S1), hypervisor 70 transmits the received image information to guest OS 101 of line-of-sight detection apparatus 10 (step S2). Upon receiving the image information, guest OS 101 generates line-of-sight information and transmits it to hypervisor 70 (step S3). Hypervisor 70 transmits the received line-of-sight information to guest OS 501 of notification control apparatus 50 (step S4).

When hypervisor 70 receives surroundings video information transmitted from a peripheral apparatus (e.g., surroundings video imager 21) (step S5), hypervisor 70 transmits the received surroundings video information to guest OS 201 of surroundings monitoring apparatus 20 (step S6). Upon receiving the surroundings video information, guest OS 201 generates target-object detection information and transmits it to hypervisor 70 (step S7).

Hypervisor 70 transmits the received target-object detection information to guest OS 501 of notification control apparatus 50 (step S8). Alert image generator 55 of notification control apparatus 50 generates, based on the line-of-sight information and the target-object detection information, alert image information displayed on, for example, image display 34 of display apparatus 30A. Guest OS 501 then transmits the alert image information to hypervisor 70 (step S9).

Hypervisor 70 transmits the received alert image information to guest OS 30A1 of display apparatus 30A (step S10). Image superimposer 33 of display apparatus 30A generates superimposed-image information based on the received alert image information. Guest OS 30A1 then transmits the superimposed-image information to hypervisor 70 (step S11). Hypervisor 70 transmits the received superimposed-image information to a peripheral apparatus (e.g., image display 34 of display apparatus 30A) (step S12).

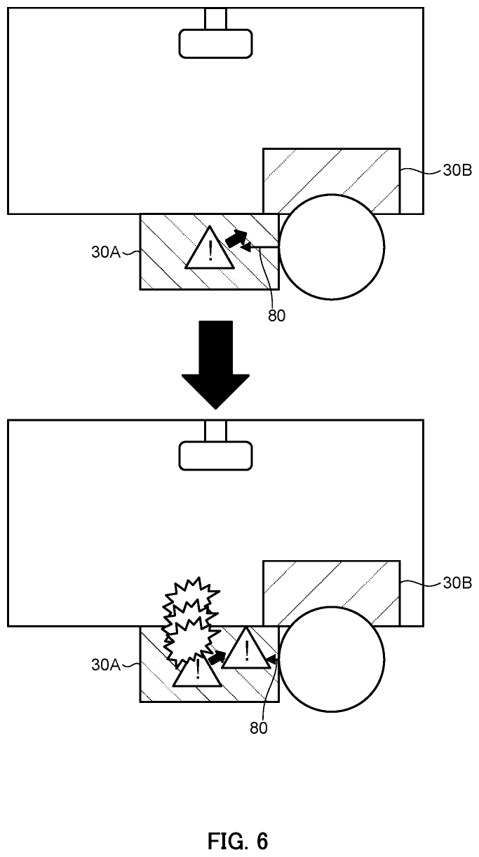

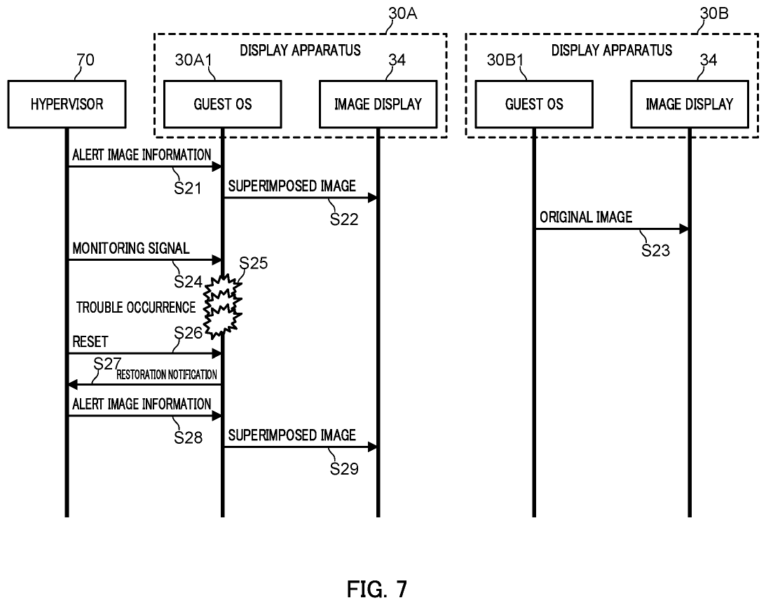

Next, with reference to FIGS. 6 and 7, a description will be given of an operation in a case where a trouble occurs in guest OS 30A1 of display apparatus 30A present in the direction toward which the line-of-sight of the driver is directed, and thereafter control by hypervisor 70 restores guest OS 30A1. FIG. 6 is a diagram for describing an operation of display control system 100 in a case where a trouble occurs in guest OS 30A1 of display apparatus 30A. FIG. 7 is a sequence chart for describing an operation in FIG. 6.

When hypervisor 70 receives alert image information transmitted from guest OS 501 of notification control apparatus 50 illustrated in FIG. 5, for example, hypervisor 70 transmits the received alert image information to guest OS 30A1 of display apparatus 30A present in the direction toward which the line-of-sight of the driver is directed (step S21).

When guest OS 30A1 receives the alert image information, as illustrated in the upper part of FIG. 6, image superimposer 33 of display apparatus 30A generates a superimposed image based on the received alert image information. Guest OS 30A1 then displays the generated superimposed image on image display 34 of display apparatus 30A (step S22).

For example, original image generator 32 of display apparatus 30B that has not received the alert image information between step S21 and step S22 generates an original image. Guest OS 30B1 of display apparatus 30B then displays the original image on image display 34 of display apparatus 30B (step S23).

Hypervisor 70 transmits, to each guest OS in a fixed cycle, a monitoring signal for monitoring a status of each guest OS such as guest OS 30A1 (step S24). Then, in a case where a response signal to the monitoring signal is not returned within the fixed cycle from a certain guest OS, such as guest OS 30A1, hypervisor 70 determines that a trouble has occurred in the certain guest OS (step S25).

When the trouble occurs in guest OS 30A1, hypervisor 70 transmits a reset signal to guest OS 30A1 (step S26). Upon receiving the reset signal, guest OS 30A1 performs trouble restoration processing based on the reset signal. Upon restoration from the trouble, guest OS 30A1 transmits, to hypervisor 70, restoration notification indicating that the restoration from the trouble is complete (step S27).

Upon receiving the restoration notification, hypervisor 70 transmits again the alert image information to guest OS 30A1 (step S28). When guest OS 30A1 receives the alert image information, as illustrated in the lower part of FIG. 6, image superimposer 33 of display apparatus 30A generates a superimposed image based on the received alert image information. Guest OS 30A1 then displays again the generated superimposed image on image display 34 of display apparatus 30A (step S29).

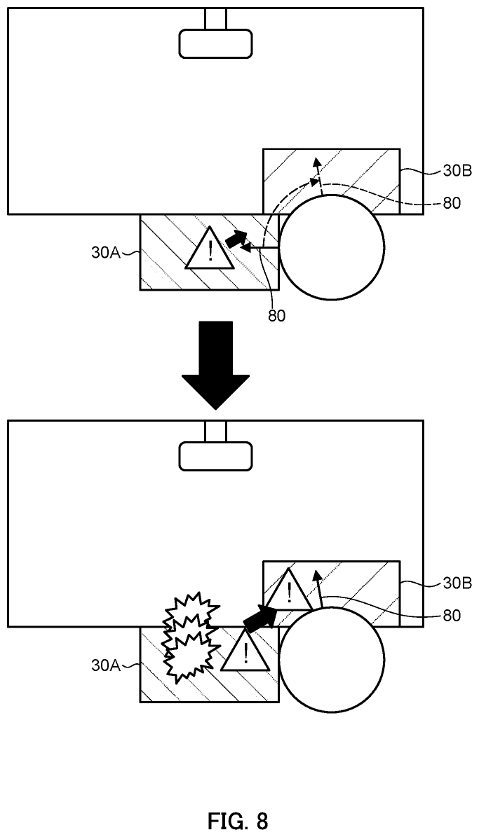

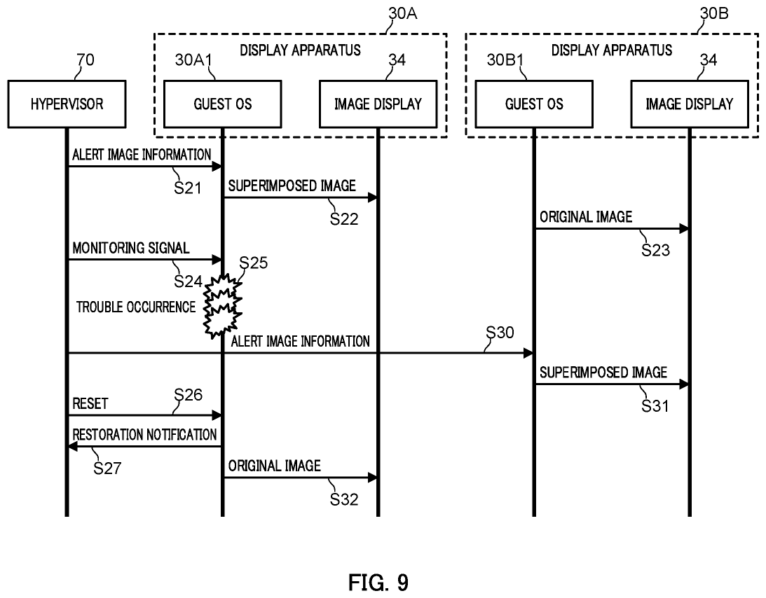

Next, with reference to FIGS. 8 and 9, a description will be given of an operation in a case where a trouble occurs in guest OS 30A1 of display apparatus 30A present in a direction toward which line-of-sight 80 of the driver is directed, and then line-of-sight 80 moves from display apparatus 30A to display apparatus 30B before the restoration of guest OS 30A1 is completed under the control of hypervisor 70.

FIG. 8 is a diagram for describing an operation of display control system 100 in a case where a trouble occurs in guest OS 30A1 of display apparatus 30A. FIG. 9 is a sequence chart for describing an operation in FIG. 8. In the following, a description of the processing similar to the processing illustrated in FIG. 7 will be omitted, and processing different from that illustrated in FIG. 7 will be described.

Assuming that, after the trouble occurs in guest OS 30A1, the line-of-sight of the driver has moved from display apparatus 30A to display apparatus 30B before hypervisor 70 transmits a reset signal to guest OS 30A1, as illustrated in the upper part of FIG. 8. In this case, a transmission destination of alert image information is not display apparatus 30A, but display apparatus 30B positioned in the present line-of-sight direction of the driver. Accordingly, when hypervisor 70 receives alert image information transmitted from guest OS 501 of notification control apparatus 50 illustrated in FIG. 5, hypervisor 70 transmits the received alert image information to guest OS 30B1 of display apparatus 30B (step S30).

When guest OS 30B1 receives the alert image information, image superimposer 33 of display apparatus 30B generates a superimposed image based on the received alert image information. Guest OS 30B1 then displays the superimposed image on image display 34 of display apparatus 30B, as illustrated in the lower part of FIG. 8 (step S31).

Subsequently, it is assumed that guest OS 30A1 of display apparatus 30A is restored by the reset signal received in step S26. At this time, guest OS 30A1 has not received any alert image information. Original image generator 32 of display apparatus 30B then generates an original image, and guest OS 30A1 displays the original image on image display 34 of display apparatus 30A (step S32).

### Guest OS Monitoring Processing Example 1

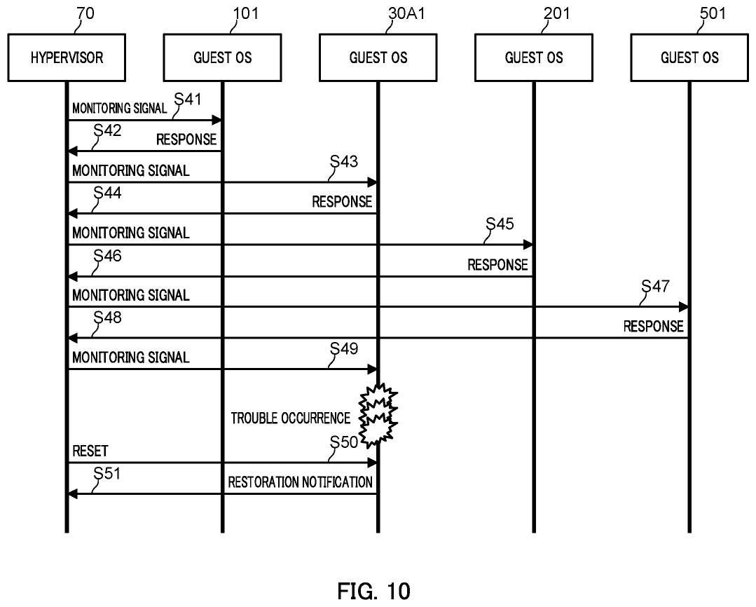

Next, a monitoring processing operation for each guest OS will be described with reference to FIGS. 10 to 12.

FIG. 10 is a sequence chart for describing an operation example of display control system 100 in a case where hypervisor 70 monitors each guest OS. In steps S41 to S48, the monitoring processing is performed on each guest OS by hypervisor 70. Specifically, first, hypervisor 70 transmits a monitoring signal to each guest OS. Hypervisor 70 then receives, from each guest OS, a response of each guest OS to the monitoring signal and thereby monitors a status of each guest OS.

It is assumed that a trouble occurs in guest OS 30A1 after the monitoring signal is transmitted to guest OS 30A1 in step S49. In this case, hypervisor 70 transmits a reset signal to guest OS 30A1 (step S50). When guest OS 30A1 is restored by the reset signal, guest OS 30A1 transmits, to hypervisor 70, restoration notification indicating that restoration from the trouble is complete (step S51).

### Guest OS Monitoring Processing Example 2

As a variation, display control system 100 may include monitoring guest OS 90, and monitoring each guest OS may be performed by monitoring guest OS90 instead of hypervisor 70. Here, monitoring guest OS 90 is an exemplary third OS according to the present disclosure. Monitoring guest OS 90 can control execution of a predetermined monitoring application that detects occurrence of a trouble related to any of the guest OSs. Incidentally, monitoring guest OS 90 may be provided in notification control apparatus 50 or may be provided to another apparatus in display control system 100.

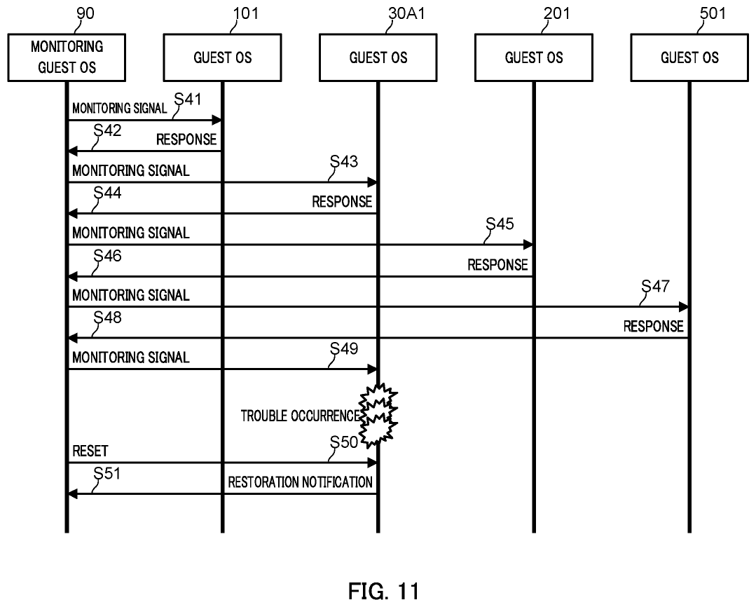

FIG. 11 is a sequence chart for describing an operation example of display control system 100 in a case where monitoring guest OS 90 monitors a status of each guest OS. In FIG. 11, for example, notification control apparatus 50 is assumed to include monitoring guest OS 90 in addition to guest OS 501. As illustrated in FIG. 11, in steps S41 to S49, the monitoring processing is performed on each guest OA by monitoring guest OS 90. Specifically, first, monitoring guest OS 90 transmits a monitoring signal to each guest OS. Monitoring guest OS 90 then receives, from each guest OS, a response of each guest OS to the monitoring signal and thereby monitors a status of each guest OS.

When occurrence of a trouble is detected in any of the guest OSs, monitoring guest OS 90 controls execution of an application that generates a reset signal for restoring the guest OS. In the example illustrated in FIG. 11, it is assumed that a trouble occurs in guest OS30 A1 after step S49. In this case, monitoring guest OS 90 transmits the reset signal to guest OS 30A1 (step S50). When guest OS 30A1 is restored by the reset signal, guest 0530A1 transmits, to monitoring guest OS 90, the restoration notification indicating that restoration from the trouble is complete (step S51). According to this variation, since monitoring guest OS 90 performs the monitoring processing, a processing load of hypervisor 70 can be reduced. Further, programming of hypervisor 70 can be also simplified.

### Guest OS Monitoring Processing Example 3

As another example, each guest OS can mutually monitor a status of another guest OS. In one example, guest OS 501 included in notification control apparatus 50 may control execution of a fourth application that detects occurrence of a trouble associated with another OS 502 included in notification control apparatus 50. OS 502 may control execution of a fifth application that detects occurrence of a trouble associated with guest OS 501.

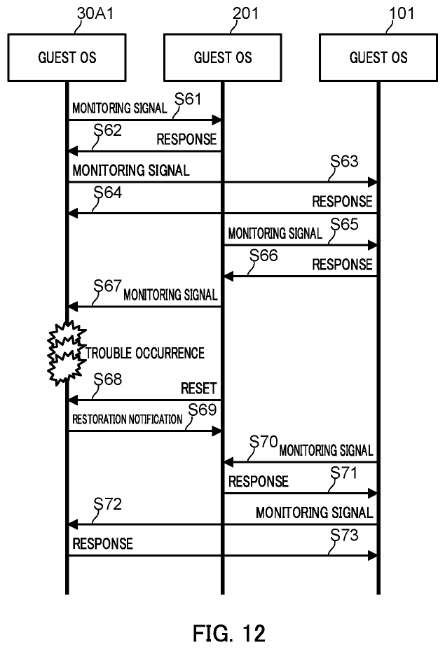

FIG. 12 is a sequence chart for describing an operation example in a case where each guest OS mutually monitors a status of another guest OS in display control system 100. In the example illustrated in FIG. 12, a plurality of guest OSs 30A1 to 101 each can control execution of an application that monitors statuses of the others. As illustrated in FIG. 12, in steps S61 to S67, the plurality of guest OSs 30A1 to 101 each performs monitoring processing on statuses of the others. For example, guest OS 30A1 controls execution of an application that monitors a status of guest OS 201 and execution of an application that monitors a status of guest OS 101. Further, guest OS 201 controls execution of an application that monitors a status of guest OS 101 and execution of an applications that monitors a status of guest OS 30A1.

Subsequently, it is assumed that a trouble occurs in guest OS 30A1, for example. In this case, guest OS 201 detects the trouble occurrence and transmits a reset signal to guest OS 30A1 (step S68). When guest OS 30A1 is restored by the reset signal, guest OS 30A1 transmits, to guest OS 201, restoration notification indicating that restoration from the trouble is complete (step S69). According to this example, the status monitoring for each guest OS can be achieved by improving the existing guest OSs without preparing monitoring guest OS 90 dedicated to monitoring.

(Effects)

As described above, notification control apparatus 50 according to the present embodiment includes: a first OS that controls execution of a first application for generating a first display image displayed on a first display apparatus mounted on a vehicle; a second OS that controls execution of a second application for generating a second display image displayed on a second display apparatus mounted on the vehicle; and a hypervisor that is executed on a processor and controls execution of the first OS and the second OS.

This enables hypervisor 70 to operate a plurality of guest OSs in parallel; thus, when a trouble occurs in any of the plurality of guest OSs, an impact range of the trouble may remain only on the display apparatus corresponding to the OS, so that the display apparatuses corresponding to the other OSs among the plurality of guest OSs can be prevented from being inoperable together with the display apparatus. Therefore, for example, even when a trouble occurs in the OS corresponding to the navigation device having a low safety requirement level, notification control apparatus 50 can continue normal processing by the other guest OSs, which can prevent inoperability of the vehicle instrument panel or the like having a high safety requirement level. Further, for example, even when displaying an alert image on the screen of the navigation device is also interrupted, the alert image can be displayed on the vehicle instrument panel or the like that is the destination to which the line-of-sight has moved, which contributes to safe driving of the driver.

(Variations)

It should be noted that, for example, the following aspects are understood that they are also within the technical scope of the present disclosure.

1. A display control device may be provided that includes: a first Operating System (OS) that controls execution of a first application for generating a first display image displayed on a first display apparatus mounted on a vehicle; a second OS that controls execution of a second application for generating a second display image displayed on a second display apparatus mounted on the vehicle; and a hypervisor that is executed on a processor and controls execution of the first OS and the second OS.

2. Among a plurality of display apparatuses including the first display apparatus and the second display apparatus, an alert image may be displayed on any of the plurality of display apparatuses that is identified by a line-of-sight direction of a driver of the vehicle, based on control by at least one OS corresponding to the display apparatus among a plurality of OSs including the first OS and the second OS, the line-of-sight direction being detected by a first detection apparatus (such as line-of-sight detection apparatus 10), the alert image being for notifying the driver of presence of an object detected by a second detection apparatus (such as surroundings monitoring apparatus) for detecting an object present around the vehicle.

3. On any of the plurality of display apparatuses that is determined in accordance with the line-of-sight direction, the alert image may be sequentially displayed while moving, based on control by the hypervisor to at least an OS corresponding to the display apparatus among the plurality of OSs.

4. The first application controlled by the first OS that has received data corresponding to the alert image transmitted from the hypervisor may be configured to generate the first display image including the alert image, and the second application controlled by the first OS that has received the data from the hypervisor may be configured to generate the second display image including the alert image.

5. The first display apparatus and the second display apparatus may be arranged in a position visible to a driver sitting on a driver seat of the vehicle.

6. A type of the first OS may be different from a type of the second OS.

7. Any of the first OS and the second OS may be a virtual OS.

8. A type of the first OS may be associated with a type of the first display apparatus; and a type of the second OS may be associated with a type of the second display apparatus.

9. The type of the first OS may be determined according to display reliability required for the first display apparatus; and the type of the second OS may be determined according to display reliability required for the second display apparatus. The display reliability is an index determined according to a risk due to a failure, as well as the safety requirements (ASIL), for example. In one example, a real-time OS having high display reliability (high real-timeness) is employed for the instrument panel, for example, and Linux (registered trademark) or the like, which has display reliability lower than that for the instrument panel but has high versatility, is adopted for the center display, for example.

10. The hypervisor may further detect occurrence of a trouble related to any of the first OS and the second OS.

11. In a case where the hypervisor detects occurrence of a trouble related to any of the first OS and the second OS, the hypervisor may perform processing on the OS for restoring the OS.

12. The display controller may further include a third OS that controls execution of a third application for detecting occurrence of a trouble related to any of the first OS and the second OS.

13. In a case where the third application detects the occurrence of the trouble, the third application may perform processing on an OS in which the trouble has occurred for restoring the OS.

14. The first OS may further control execution of a fourth application for detecting occurrence of a trouble related to the second OS, and the second OS may further control execution of a fifth application for detecting occurrence of a trouble related to the first OS.

15. The fourth application may perform processing on the second OS for restoring the second OS in a case where the fourth application detects occurrence of a trouble related to the second OS, and the fifth application may perform processing on the first OS for restoring the first OS in a case where the fifth application detects occurrence of a trouble related to the first OS.

16. In the display control apparatus, robustness of a type of either one of the first OS or the second OS may be higher than robustness of a type of the other one of the first OS or the second OS. The robustness is an index indicating, for example the difficulty of error occurrence and the security performance level.

17. In the display control apparatus, real-timeness of a type of either one of the first OS or the second OS may be higher than real-timeness of a type of the other one of the first OS or the second OS. The real-timeness is an index indicating, for example, the performance or ability of an OS to complete specific processing within a predetermined time period.

18. The display control apparatus may further include the above-described processor.

19. A display control system may be provided that includes: a first OS that controls execution of a first application for generating a first display image displayed on a first display apparatus mounted on a vehicle; a second OS that controls execution of a second application for generating a second display image displayed on a second display apparatus mounted on the vehicle; and a hypervisor that is executed on a processor and controls execution of the first OS and the second OS.

20. A display control method executed in a display control apparatus may be provided, the display control method including: controlling, by a first OS, execution of a first application for generating a first display image displayed on a first display apparatus mounted on a vehicle; controlling, by a second OS, execution of a second application for generating a second display image displayed on a second display apparatus mounted on the vehicle; and controlling, by a hypervisor that is executed on a processor, execution of the first OS and the second OS.

Hereinabove, various embodiments have been described with reference to the drawings, it is needless to say that the present disclosure is not limited to such examples. It will be apparent to those skilled in the art may arrive at various modifications or variations at within the scope of the claims, and it is naturally understood that they are also within the technical scope of the present disclosure. In addition, the components in the above embodiments may be optionally combined without departing from the spirit and scope of the disclosure.

While specific examples of the present invention have been described in detail thus far, these examples are merely illustrative and do not limit the appended claims. The art described in the appended claims includes various modifications and variations of the specific examples illustrated above.

While various embodiments have been described herein above, it is to be appreciated that various changes in form and detail may be made without departing from the spirit and scope of the invention(s) presently or hereafter claimed.

This application is entitled and claims the benefit of Japanese Patent Application No. 2020-060560, filed on Mar. 30, 2020, the disclosure of which including the specification, drawings and abstract is incorporated herein by reference in its entirety.

### INDUSTRIAL APPLICABILITY

An exemplary embodiment of the present disclosure is preferable for a display control apparatus and a display control system.

### REFERENCE SIGNS LIST

10 Line-of-sight detection apparatus
20 Surroundings monitoring apparatus
30A, 30B, 30C display apparatus
50 Notification control apparatus
70 Hypervisor
100 Display control system

1. A display control apparatus, comprising:
a first Operating System (OS) that controls execution of a first application for generating a first display image displayed on a first display apparatus mounted on a vehicle;
a second OS that controls execution of a second application for generating a second display image displayed on a second display apparatus mounted on the vehicle; and
a hypervisor that is executed on a processor and controls execution of the first OS and the second OS.

2. The display control apparatus according to claim 1, wherein, among a plurality of display apparatuses including the first display apparatus and the second display apparatus, an alert image is displayed on any of the plurality of display apparatuses that is identified by a line-of-sight direction of a driver of the vehicle, based on control by at least one OS corresponding to the display apparatus among a plurality of OSs including the first OS and the second OS, the line-of-sight direction being detected by a first detection apparatus, the alert image being for notifying the driver of presence of an object detected by a second detection apparatus for detecting an object present around the vehicle.

3. The display control apparatus according to claim 2, wherein, on any of the plurality of display apparatuses that is determined in accordance with the line-of-sight direction, the alert image is sequentially displayed while moving, based on control by the hypervisor to at least an OS corresponding to the display apparatus among the plurality of OSs.

4. The display control apparatus according to claim 2, wherein:
the first application controlled by the first OS that has received data corresponding to the alert image transmitted from the hypervisor generates the first display image including the alert image; and
the second application controlled by the first OS that has received the data from the hypervisor generates the second display image including the alert image.

5. The display control apparatus according to claim 1, wherein the first display apparatus and the second display apparatus are arranged in a position visible to a driver sitting on a driver seat of the vehicle.

6. The display control apparatus according to claim 1, wherein a type of the first OS is different from a type of the second OS.

7. The display control apparatus according to claim 1, wherein any of the first OS and the second OS is a virtual OS.

8. The display control apparatus according to claim 1, wherein:
a type of the first OS is associated with a type of the first display apparatus; and
a type of the second OS is associated with a type of the second display apparatus.

9. The display control apparatus according to claim 8, wherein:
the type of the first OS is determined according to display reliability required for the first display apparatus; and
the type of the second OS is determined according to display reliability required for the second display apparatus.

10. The display control apparatus according to claim 1, wherein the hypervisor further detects occurrence of a trouble related to any of the first OS and the second OS.

11. The display control apparatus according to claim 10, wherein, in a case where the hypervisor detects occurrence of a trouble related to any of the first OS and the second OS, the hypervisor performs processing on the OS for restoring the OS.

12. The display control apparatus according to claim 1, further comprising a third OS that controls execution of a third application for detecting occurrence of a trouble related to any of the first OS and the second OS.

13. The display control apparatus according to claim 12, wherein, in a case where the third application detects the occurrence of the trouble, the third application performs processing on an OS in which the trouble has occurred for restoring the OS.

14. The display control apparatus according to claim 1, wherein:
the first OS further controls execution of a fourth application for detecting occurrence of a trouble related to the second OS; and
the second OS further controls execution of a fifth application for detecting occurrence of a trouble related to the first OS.

15. The display control apparatus according to claim 14, wherein:
the fourth application performs processing on the second OS for restoring the second OS in a case where the fourth application detects occurrence of a trouble related to the second OS; and
the fifth application performs processing on the first OS for restoring the first OS in a case where the fifth application detects occurrence of a trouble related to the first OS.

16. The display control apparatus according to claim 1, wherein robustness of a type of either one of the first OS or the second OS is higher than robustness of a type of the other one of the first OS or the second OS.

17. The display control apparatus according to claim 1, wherein real-timeness of a type of either one of the first OS or the second OS is higher than real-timeness of a type of the other one of the first OS or the second OS.

18. The display control apparatus according to claim 1, further comprising the processor.

19. A display control system, comprising:
a first OS that controls execution of a first application for generating a first display image displayed on a first display apparatus mounted on a vehicle;
a second OS that controls execution of a second application for generating a second display image displayed on a second display apparatus mounted on the vehicle; and
a hypervisor that is executed on a processor and controls execution of the first OS and the second OS.

20. A display control method executed in a display control apparatus, the display control method comprising:
controlling, by a first OS, execution of a first application for generating a first display image displayed on a first display apparatus mounted on a vehicle;
controlling, by a second OS, execution of a second application for generating a second display image displayed on a second display apparatus mounted on the vehicle; and
controlling, by a hypervisor that is executed on a processor, execution of the first OS and the second OS.
